(19) United States
(12) Patent Application Publication
(10) Pub. No.: US 2016/0218446 A1
(43) Pub. Date: Jul. 28, 2016

(54) CONTACT, CONNECTOR AND ELECTRONIC DEVICE

(71) Applicant: FUJITSU LIMITED, Kawasaki-shi (JP)

(72) Inventor: Koki Takahashi, Kawasaki (JP)

(73) Assignee: FUJITSU LIMITED, Kawasaki-shi (JP)

(21) Appl. No.: 14/973,108

(22) Filed: Dec. 17, 2015

(30) Foreign Application Priority Data
Jan. 28, 2015 (JP) 2015-014119

(51) Int. Cl. H01R 4/28; H01R 13/73; H01R 13/42

(52) U.S. Cl. CPC H01R 4/28; H01R 13/42; H01R 13/73

(57) ABSTRACT

A contact includes: a spring portion having a meander shape and including a flat portion and a folded portion; a contact point located at one end side of the spring portion; and a protrusion formed on the flat portion.

And a connector includes: a contact; and a housing that accommodates the contact, wherein the contact includes: a spring portion having a meander shape and including a flat portion and a folded portion; a contact point located at one end side of the spring portion; and a protrusion formed on the flat portion.

### CROSS-REFERENCE TO RELATED APPLICATION

This application is based upon and claims the benefit of priority from the prior Japanese Patent Application No. 2015-014119, filed on Jan. 28, 2015, the entire contents of which are incorporated herein by reference.

### FIELD

The embodiments discussed herein are related to a contact, a connector, and an electronic device.

### BACKGROUND

Recently, electronic devices such as, for example, smart-phones or tablet type terminals (hereinafter referred to as “tablets”) have been widely used as information devices. The functions of such electronic devices may be expanded by connecting the electronic devices to a cradle or a keyboard dock.

In general, electronic devices such as, for example, smart-phones or tablets are removably connected to a cradle or a keyboard dock via a connector. For example, a plurality of flat plate-shaped pads (electrodes) is formed in a tablet, and contacts (contactors) are formed in a cradle or a keyboard dock, such that the pads and the contacts elastically come into contact with each other. By this, the tablet and the cradle or the keyboard dock may be simply electrically connected to each other, and may also be simply separated from each other. In addition, as for the contacts for use in such a purpose, pogo pins or leaf springs are used.

Hereinafter, an electronic device formed with a contact will be simply referred to as an electronic device, and an electronic device formed with a pad to be connected to the contact will be referred to as a counterpart device.

In the conventional contact, a contact failure may be caused by an oxide film or foreign matter attached to a surface of the pad or the contact.

The following are reference documents.

### [Document 1] Japanese Laid-Open Patent Publication No. 2005-129374 and

### [Document 2] Japanese Laid-Open Patent Publication No. 2008-026171.

### SUMMARY

According to an aspect of the invention, a contact includes: a spring portion having a meander shape and including a flat portion and a folded portion; a contact point located at one end side of the spring portion; and a protrusion formed on the flat portion.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are views illustrating one example of a contact;

FIGS. 2A and 2B are views illustrating another example of a contact;

FIGS. 3A and 3B are sectional views illustrating a contact of an exemplary embodiment;

FIGS. 4A to 4D are views for explaining the operation of a contact of an exemplary embodiment;

FIG. 5 is a view for explaining the operation of a contact of an exemplary embodiment;

FIGS. 6A to 6D are views for explaining the operation of a contact of an exemplary embodiment;

FIG. 7 is a perspective view illustrating one example of a connector including contacts of an exemplary embodiment;

FIG. 8 is a view illustrating a cross section of the connector of FIG. 7;

FIG. 9 is a view illustrating one example of an electronic device including a connector;

FIG. 10 is a plan view illustrating pads formed on a casing of a tablet;

FIG. 11 is a sectional view illustrating a contact according to Modification 1;

FIG. 12 is a view illustrating a relationship between a position of a protrusion and a position at which a sliding direction is switched;

FIG. 13 is a sectional view illustrating a contact according to Modification 2;

FIG. 14 is a view illustrating a relationship between a position of a contact portion P in a horizontal direction (a sliding amount) and a position of the contact portion P in a height direction (a displacement amount); and

FIG. 15 is a sectional view illustrating a contact that is not formed with a protrusion (Comparative Example).

### DESCRIPTION OF EMBODIMENTS

Hereinafter, prior to describing the exemplary embodiments, preliminary matters will be described to facilitate the understanding of the exemplary embodiments.

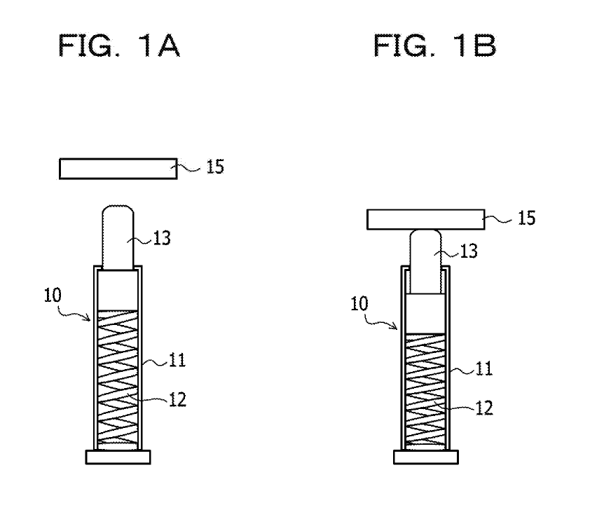

FIGS. 1A and 1B are views illustrating one example of a contact. FIG. 1A illustrates a state in which a contact 10 is not in contact with a pad 15, and FIG. 1B illustrates a state in which the contact 10 and the pad 15 are in contact with each other.

The contact 10 illustrated in FIGS. 1A and 1B is referred to as a pogo pin or a spring probe, and includes a cylinder portion 11, a coil spring 12 placed within the cylinder portion 11, and a bar-shaped pin 13. All of the cylinder portion 11, the coil spring 12, and the pin 13 are formed of a metal.

When an electronic device and a counterpart device are connected to each other, a tip end of the pin 13 comes into contact with the pad 15, thereby causing the coil spring 12 to be compressed as illustrated in FIG. 1B. Thus, the pin 13 and the pad 15 are always in contact with each other under a substantially constant pressure by the elastic force of the coil spring 12.

This type of contact 10 may be arranged at a high density because the projection area of the contact 10 in relation to the pad surface is small, and therefore is advantageous for the connection of an electronic device including a large number of contacts. However, in this type of contact 10, the pin 13 and the pad 15 are not slid in relation to each other when they are in contact with each other, and thus a contact failure may occur as an oxide film or foreign matter is attached to the tip end of the pin 13 or the surface of the pad 15.

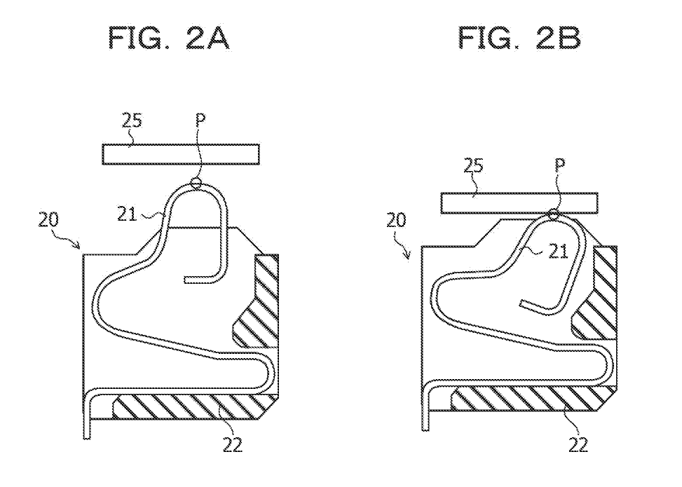

FIGS. 2A and 2B are views illustrating another example of a contact. FIG. 2A illustrates a state in which a contact 21 is not in contact with a pad 25, and FIG. 2B illustrates a state in which the contact 21 and the pad 25 are in contact with each other.

The connector 20 includes a contact 21 and a housing 22. The contact 21 is a leaf spring formed by bending a metal plate into a prescribed shape. One end side of the contact 21 is fixed to the inside of the housing 22 and a U-shaped curved portion of the other end side of the contact 21 comes into contact with the pad 25 of the counterpart device. Here, the portion of the contact 21 that comes into contact with the pad 25 will be referred to as a contact portion P.

When the electronic device and the counterpart device are connected to each other, the contact 21 is deformed and in accordance with the deformation of the contact 21, the contact portion P moves while rubbing the surface of the pad 25, as illustrated in FIG. 2B. Therefore, even if an oxide film or foreign matter is attached to the surface of the contact 21 or the pad 25, the oxide film or impurities will be scraped by the movement (sliding) of the contact portion P so that a clean surface will be exposed.

However, the contact 21 illustrated in FIGS. 2A and 2B has a large size as compared to the contact 10 illustrated in FIGS. 1A and 1B, and thus may not be arranged at a high density. In addition, since the contact portion P moves only in one direction within a limited range when the contact 21 and the pad 25 come into contact with each other, the oxide film or foreign matter scraped by the movement of the contact portion P is deposited near the end point of the range of movement of the contact portion P. Therefore, when the attachment and detachment of the contact 21 and the pad 25 are repeated, the contact 21 is placed on the oxide or the foreign matter, which may cause a contact failure.

In the following exemplary embodiment, descriptions will be made on a contact in which a contact failure hardly occurs even if the contact is used for a long term.

### EXEMPLARY EMBODIMENT

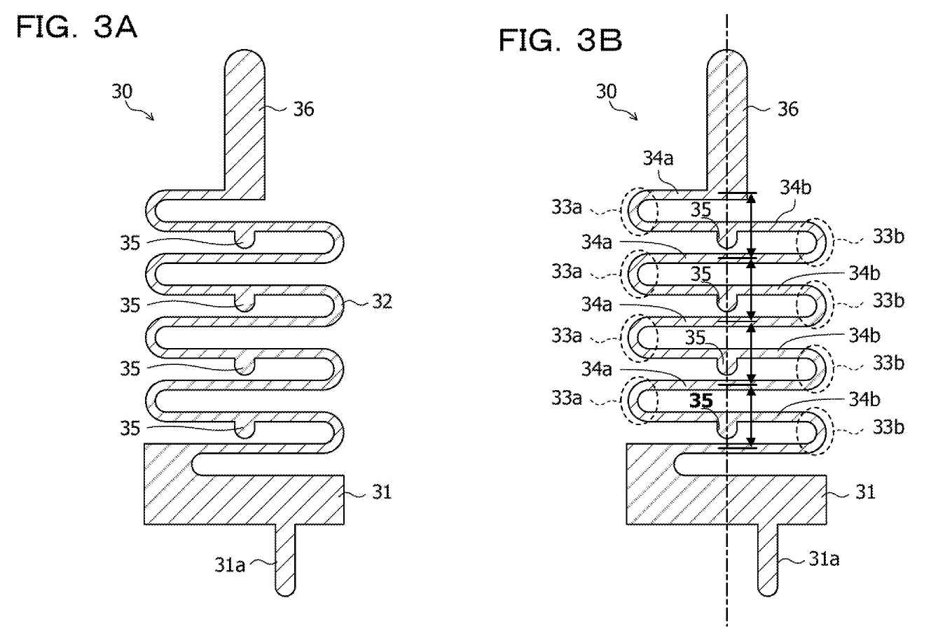

FIG. 3A and 3B are sectional views illustrating a contact (contactor) according to an exemplary embodiment.

As illustrated in FIG. 3A, a contact 30 according to the present exemplary embodiment includes a base portion 31, a spring portion 32, and a pin 36. The pin 36 is an example of a contact point. A terminal 31a to be connected to a circuit board (not illustrated) is formed on the lower side of the base portion 31.

In the contact 30 according to the present exemplary embodiment, the base portion 31, the terminal 31a, the spring portion 32, and the pin 36 of the contact are integrally formed by a copper alloy or other metals.

The spring portion 32 is formed by processing a strip-shaped metal plate into a meander shape. As illustrated in FIG. 3B, the spring portion 32 is disposed on the base portion 31 such that its centerline (indicated by a one-dot dash line in FIG. 3B) is vertically arranged. A lower end of the spring portion 32 is connected to the base portion 31. In the contact 30 illustrated in FIGS. 3A and 3B, the spring portion 32 is folded four times at each of the left side and the right side of the centerline.

Hereinafter, for the convenience of description, the portions of the spring portion 32 folded at the left side of the centerline as in FIG. 3B will be referred to as folded portions 33a, and the portions of the spring portion 32 folded at the right side of the centerline as in FIG. 3B will be referred to as folded portions 33b. In addition, in the spring portion 32, a linear portion that interconnects the foot of the pin 36 or a lower end of the folded portion 33b and an upper end of each folded portion 33a will be referred to as a flat portion 34a, and a linear portion that interconnects a lower end of each folded portion 33a and an upper end of each folded portion 33b to each other will be referred to as a flat portion 34b. In addition, one cycle portion of the spring portion 32 of the meander shape (represented by an arrow in FIG. 3B) will be referred to as one (1) pitch. In the example illustrated in FIGS. 3A and 3B, it may be said that the spring portion 32 includes the folded portions corresponding to four (4) pitches.

In the spring portion 32, one protrusion 35 is formed per pitch. In the present exemplary embodiment, the protrusion 35 is formed on the lower surface of each flat portion 34b. In a state where no stress is applied to the spring portion 32, a gap is present between a tip end (lower end) of each protrusion 35 and the flat portion 34a beneath it.

The pin 36 is a rod-shaped member, and is disposed on the upper end of the spring portion 32. The tip end (upper end) of the pin 36 comes into contact with the pad of the counterpart device. In the present exemplary embodiment, the centerline of the pin 36 coincides with the centerline of the spring portion 32. In addition, the protrusion 35 is disposed on the centerline of the spring portion 32.

Meanwhile, while the case where the protrusions 35 protrude downward from the flat portions 34b, respectively, is described in the present exemplary embodiment, the protrusions 35 may protrude upward from the flat portions 34b, respectively. In addition, the protrusions 35 may protrude upward or downward from the flat portions 34a, respectively.

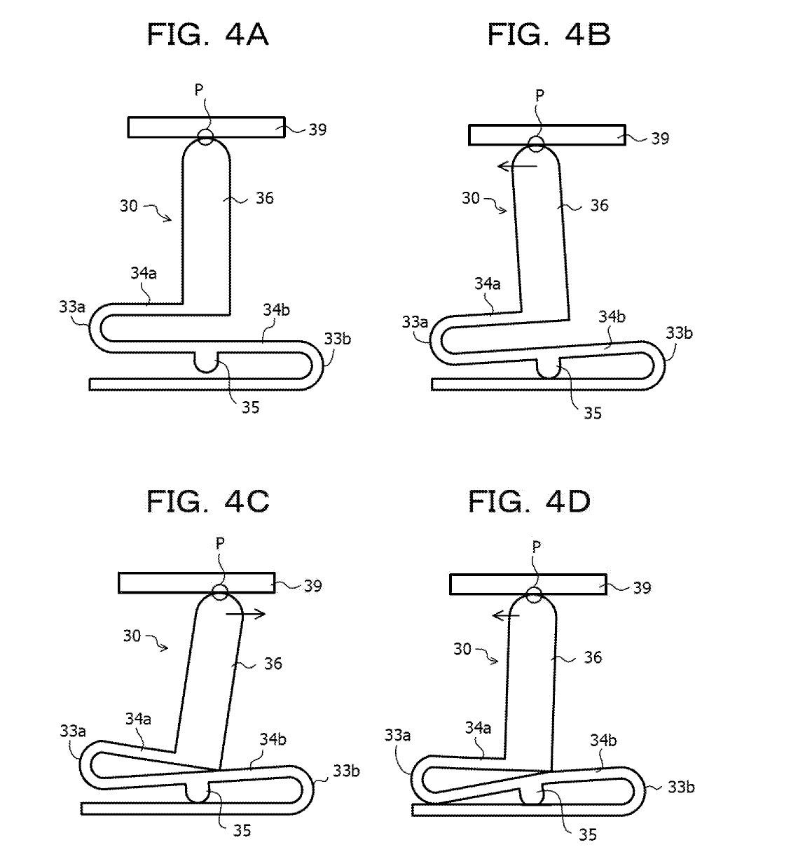

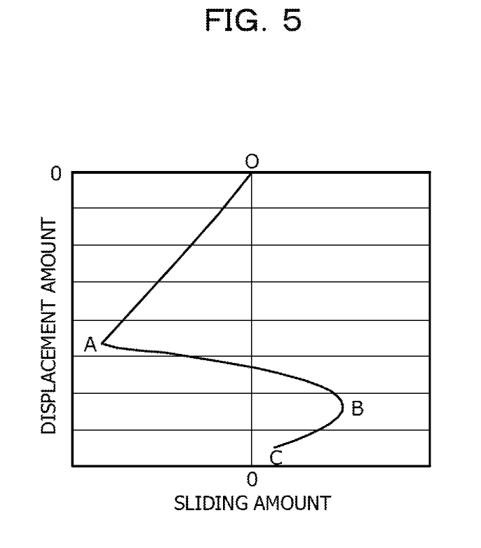

Hereinafter, the operation of the above-described contact 30 will be described with reference to FIGS. 4A to 4D and FIG. 5. FIGS. 4A to 4D illustrate the spring portion 32 corresponding to one (1) pitch. Here, as illustrated in FIGS. 4A to 4D, it is assumed that a pad (electrode) 39 formed in the counterpart device moves from the top side to the bottom side of the contact 30.

FIG. 5 is a view illustrating a relationship between a position of a contact P in a horizontal direction (hereinafter, referred to as a “sliding amount”) and a position of the contact in a height direction (hereinafter, referred to as a “displacement amount”) in which the horizontal axis represents the sliding movement and the vertical axis represents the displacement amount. Here, both the sliding amount and the displacement amount are based on the origin (zero (0) point) where the pin 36 and the pad 39 initially come into contact with each other. In addition, in FIG. 5, the left end of the sliding range of the contact portion P is indicated by A, the right end is indicated by B, and the end point position of the contact portion P is indicated by C.

As in FIG. 4A, when the pad 39 moves downward to come into contact with the tip end of the pin 36, stresses act in the direction of compressing the spring portion 32. The stresses are mainly concentrated on the folded portions 33a and 33b, so that the spring portion 32 is deformed such that the curvature of the folded portions 33a and 33b is reduced.

In the example illustrated in FIG. 4A, since the flat portion 34b is longer than the flat portion 34a, the flat portion 34b is tilted downward with the folded portion 33b as a fulcrum. Accordingly, as in FIG. 4B, the contact portion P (the tip end portion of the pin 36) moves leftward. The movement of the contact portion P at that time corresponds to a movement from the origin (zero (0) point) to point A in FIG. 5.

Thereafter, when the pad 39 moves further downward, the protrusion 35 comes into contact with the flat portion 34a beneath it as in FIG. 4B. Accordingly, the flat portion 34b may not be tilted any further. Therefore, as in FIG. 4C, the flat portion 34a is tilted downward with the folded portion 33a as a fulcrum. As a result, the contact portion P moves rightward. The movement of the contact portion P at that time corresponds to a movement from point A to point B in FIG. 5.

When the pad 39 moves further downward, the flat portion 34b comes into contact with the flat portion 34a as in FIG. 4C. Then, when the pad 39 moves further downward, a portion of the flat portion 34 at the left side of the protrusion 35 is curved as in FIG. 4D. Accordingly, the tip end of the pin 36 (the contact portion P) moves leftward with the protrusion 35 as a fulcrum. The movement of the contact portion P at that time corresponds to a movement from point B to point C in FIG. 5. As in FIG. 5, the movement distance from point B to point C is shorter than the movement distance from point A to point B.

As described above, in the present exemplary embodiment, in accordance with the downward movement of the pad 39, the contact portion P moves leftward from the origin (zero (0) point) to point A, then moves rightward from point A to point B, and then further moves leftward from point B to point C. Through this movement of the contact portion P, an oxide film or foreign matter attached to the tip end portion of the point 36 or the surface of the pad 39 is scraped, so that a clean pad surface is exposed between point A and point B. In addition, the contact portion P finally reaches point C between point A and point B. Accordingly, a contact failure between the pin 36 and the pad 39, which is caused by the oxide film or foreign matter, may be avoided.

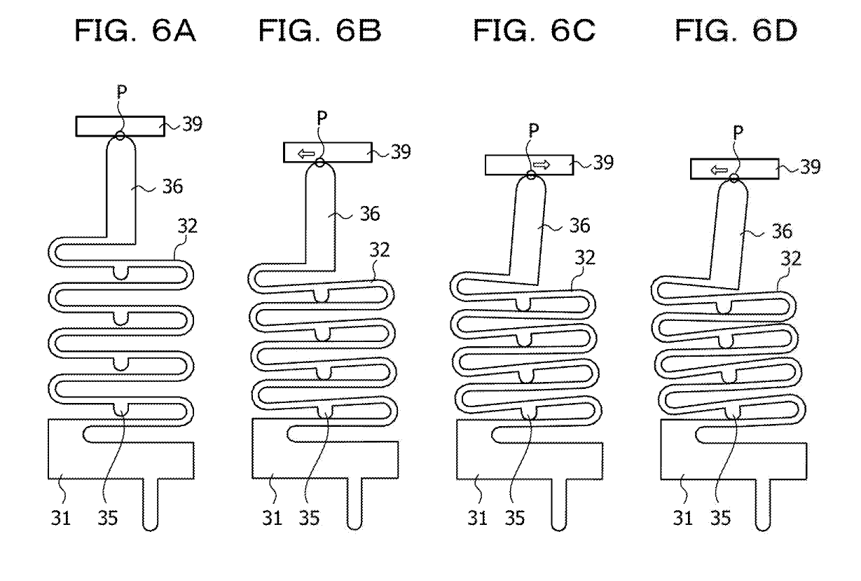

While descriptions have been made on the case where the number of pitches of the spring portion 32 is one (1) with reference to FIGS. 4A to 4D, FIGS. 6A to 6D illustrate the deformation of the spring portion 32 in the case where the number of pitches is four (4).

FIG. 6A illustrates the shape of the spring portion 32 when the pad 39 and the tip end of the pin 36 come into contact with each other. When the pad 39 moves downward in this state, the contact portion P moves leftward as in FIG. 6B. Thereafter, when the protrusions 35 and the flat portions 34a come into contact with each other, the contact portion P moves rightward as in FIG. 6C. When the pad 39 moves further downward and thus the flat portion 34a and the flat portion 34b come into contact with each other, the contact portion P moves slightly leftward as in FIG. 6D. Then, the pin 36 and the pad 39 come into contact with each other on the clean surface from which the oxide film or foreign matter has been removed.

Even in the contact 30 illustrated in FIGS. 6A to 6D, the contact portion P moves leftward and downward in accordance with the downward movement of the pad 39, and as a result, an oxide film or foreign matter is removed to expose a clean surface, as in the contact where the number of pitches is one (1) as illustrated in FIGS. 4A to 4D. Then, the contact portion P is finally disposed on the clean surface. In this way, a contact failure, which is caused by the oxide film or foreign matter, may be avoided. In addition, since the contact 30 according to the present embodiment has a relatively small projection area on the pad surface, the contact 30 may be advantageously arranged at a higher density compared to, for example, the contact using the leaf spring illustrated in FIGS. 2A and 2B.

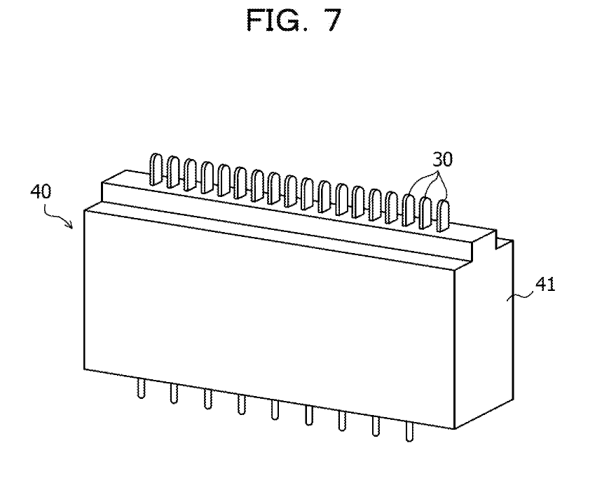

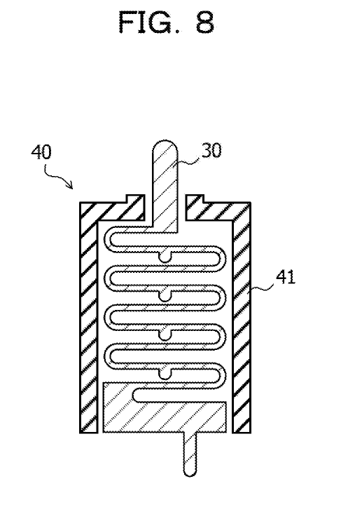

FIG. 7 is a perspective view illustrating one example of a connector including the contacts 30 described above, and FIG. 8 is a view illustrating a cross section of the connector.

The connector 40 illustrated in FIGS. 7 and 8 includes a plurality of contacts 30 arranged in one direction and a housing 41 that accommodates the contacts 30. The housing 41 is formed of an insulative resin.

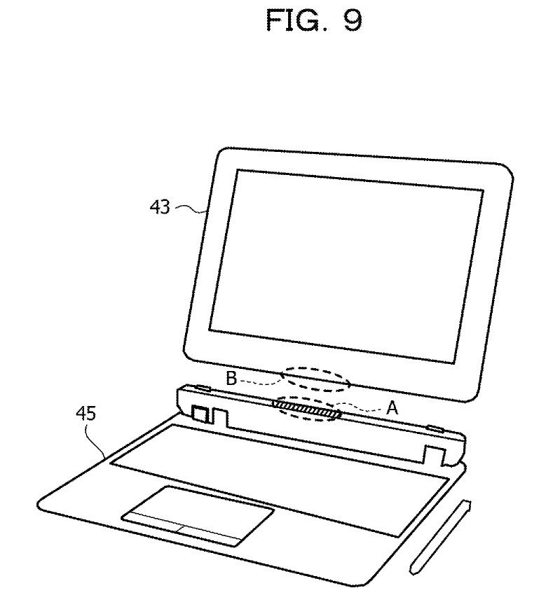

FIG. 9 is a view illustrating one example of an electronic device that including the connector 40 described above. In FIG. 9, reference numeral 43 denotes a tablet, and reference numeral 45 denotes a keyboard dock attached to/detached from the tablet 43. The tablet 43 is one example of a counterpart device, and the keyboard dock 45 is one example of an electronic device.

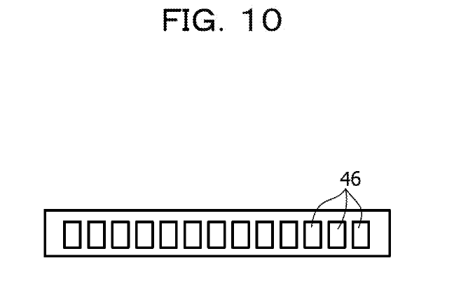

The connector 40 as illustrated in FIG. 7 is attached to a casing portion of the keyboard dock 45 which is represented by the dash line A in FIG. 9. In addition, as illustrated in FIG. 10, a plurality of pads 46 is arranged and formed on a casing portion of the tablet 43 which is represented by the dash line B in FIG. 9. When each contact 30 of the connector 40 and each pad 46 of the tablet 43 are electrically connected to each other, the tablet 43 may be controlled by the keys formed in the keyboard dock 45.

### Modification 1

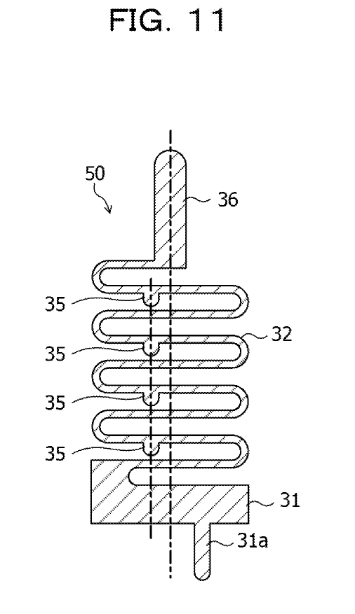

FIG. 11 is a sectional view illustrating a contact 50 according to Alternative Example 1 of the exemplary embodiment. In FIG. 11, elements that are the same as those in FIG. 3 are denoted by the same reference numerals, and a detailed description thereof will be omitted.

In the contact 30 illustrated in FIGS. 3A and 3B, the protrusions 35 are located on the centerline of the spring portion 32. On the other hand, in the contact 50 of Modification 1 illustrated in FIG. 11, each protrusion 35 is located at a position deviated rightward or leftward (leftward in the example of FIG. 11) from the centerline of the spring portion 32.

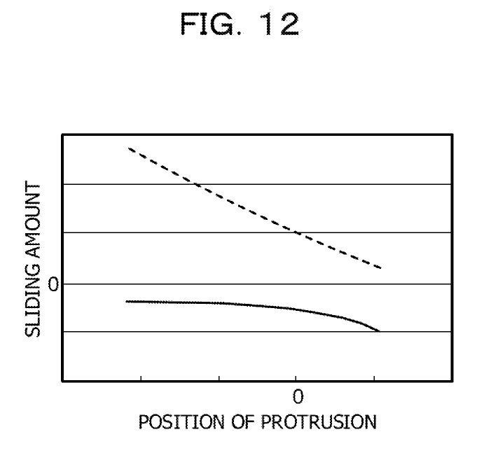

FIG. 12 is a view illustrating a relationship between a position of a protrusion 35 and a sliding direction switching position of the protrusion 35 which are represented on the horizontal axis and the vertical axis, respectively. In FIG. 12, the solid line represents the position where the sliding direction is switched from the left direction (negative (−) direction) to the right direction (positive (+) direction), and the dash line represents the position where the sliding direction is switched from the right direction (positive (+) direction) to the left direction (negative (−) direction).

As illustrated in FIG. 12, the sliding range of the contact portion P may be adjusted by displacing the position of the protrusion 35 rightward or leftward from the centerline of the spring portion 32.

### Modification 2

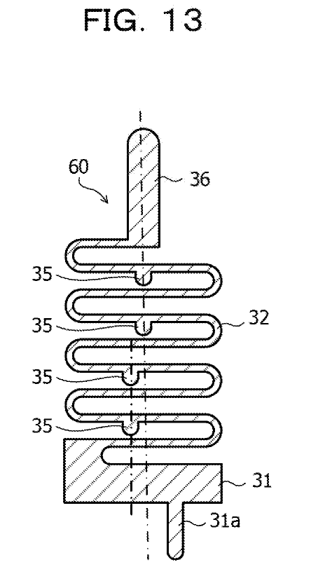

FIG. 13 is a sectional view illustrating a contact 60 according to Modification 2 of the exemplary embodiment. In FIG. 13, elements that are the same as those in FIG. 3 are denoted by the same reference numerals, and a detailed description thereof will be omitted.

In the contact 60 illustrated in FIG. 13, one protrusion 35 is formed per pitch, as in the contact 30 illustrated FIG. 3. However, in the contact 60 illustrated in FIG. 13, two upper protrusions 35 are arranged on the centerline of the spring portion 32, and two lower protrusions 35 are arranged at the left side of the centerline.

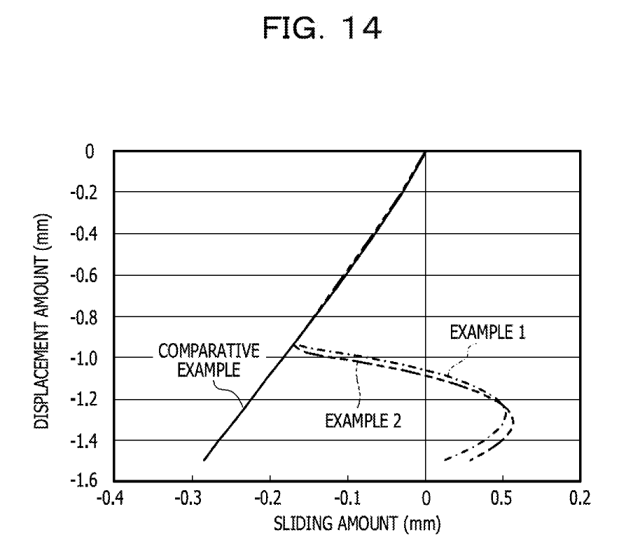

FIG. 14 is a view illustrating a relationship between a position of the contact portion P in the horizontal direction (a sliding amount)and a position of the contact portion P in the height direction (a displacement amount) which are represented on the horizontal axis and the vertical axis, respectively. Both the sliding amount and the displacement amount are based on the origin (zero (0) point) where the pin 36 and the pad 39 initially come into contact with each other.

Meanwhile, here, the width of the spring portion 32 (the distance from the left folded portions to the right folded portions) is set to 5 mm, the length of the spring portion 32 (the length in a non-compressed state) is set to 7 mm, and the length of the pin 36 is set to 3.5 mm.

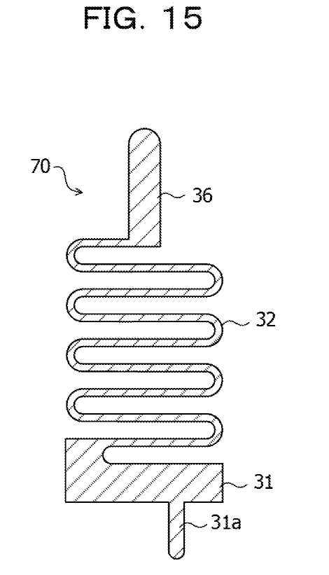

Example 1 (the one-dot dash line) in FIG. 14 represents the movement of the contact portion P in the contact 30 illustrated in FIG. 3, and Example 2 (the double-dot dash line) represents the movement of the contact portion P in the contact 60 illustrated in FIG. 13. In addition, Comparative Example (the solid line) in FIG. 14 represents the movement of the contact portion P in a contact 70 (Comparative Example) that is not formed with a protrusion as illustrated in FIG. 15.

As depicted in FIG. 14, the sliding range of the contact portion P may be controlled by adjusting the position of the protrusions 35.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A contact comprising:
a spring portion having a meander shape and including a flat portion and a folded portion;
a contact point located at one end side of the spring portion; and
a protrusion formed on the flat portion.

2. The contact according to claim 1, wherein the protrusion is located on a centerline of the spring portion.

3. The contact according to claim 1, wherein the protrusion is located at a position deviated from a centerline of the spring portion.

4. The contact according to claim 1, wherein a tip end of the protrusion does not come into contact with the flat portion adjacent thereto in a state where the spring portion is not in a compressed state.

5. The contact according to claim 1, wherein one protrusion is formed per pitch of the spring portion.

6. The contact according to claim 1, wherein the spring portion, the contact point, and the protrusion are integrally formed by a metal.

7. A connector comprising:
a contact; and
a housing that accommodates the contact,
wherein the contact includes:
a spring portion having a meander shape and including a flat portion and a folded portion;
a contact point located at one end side of the spring portion; and
a protrusion formed on the flat portion.

8. An electronic device comprising:
a casing; and
a connector including a contact and a housing that accommodates the contact, the connector being attached to the casing,
wherein the contact of the connector includes:
a spring portion having a meander shape and including a flat portion and a folded portion;
a contact point located at one end side of the spring portion; and
a protrusion formed on the flat portion.
